(19) United States
(12) Patent Application Publication
(10) Pub. No.: US 2010/0167412 A1
(43) Pub. Date: Jul. 1, 2010

(54) SENSOR SYSTEM FOR DETERMINING CONCENTRATION OF CHEMICAL AND BIOLOGICAL ANALYTES

(76) Inventors: Caibin XIAO, Harleysville, PA (US); Prashant Vishwanath Shrikhande, Eden Prairie, MN (US)

Correspondence Address: General Electric Company;GE Global Patent Operation, 2 Corporate Drive, Suite 648, Shelton, CT, 06484, US

(21) Appl. No.: 12/346,960

(22) Filed: Dec. 31, 2008

(51) Int. Cl. G01N 21/00

(52) U.S. Cl. 436/171; 422/82.05; 436/164; 436/172

(57) ABSTRACT

A sensor system for determining a concentration of chemical and biological analytes is disclosed, which comprises a disposable reagent-carrying pipette tip; a liquid handling unit to which the pipette tip can be detachably mounted, the liquid handling unit capable of withdrawing liquid into the pipette tip; at least one light source; at least one photodetector, the detector capable of generating an electronic signal response indicative of light passed through or generated from the interior space of the pipette tip; and an electronic circuit means for processing, storing and transmitting the electronic signal response and controlling the light source.

### BACKGROUND OF THE INVENTION

1. Field of the Invention

The present invention relates generally to sensors used in analysis of samples, and in particular relates to methods that allow integration of sample handling, reagent addition, and spectrophotometric measurement into an integrated handheld sensor system.

2. Description of Related Art

Sensor methods for quantification of volatile and nonvolatile compounds in fluids are known in the art. Typically, quantification of these parameters is performed using dedicated sensor systems that are specifically designed for this purpose. These sensor systems operate using a variety of principles including electrochemical, optical, acoustic, and magnetic. For example, sensor systems are used to conduct optical inspection of biological, chemical, and biochemical samples. A variety of spectroscopic sensors operating with colorimetric liquid and solid reagents have been developed. In fact, spectrophotometric indicators in analytical chemistry have become the reagents of choice in many commercially available optical sensors and probes.

Optical sensors possess a number of advantages over other sensor types, the most important being their wide range of transduction principles: optical sensors can respond to analytes for which other sensors are not available. Also, with optical sensors it is possible to perform not only “direct” analyte detection, in which the spectroscopic features of the analyte are measured, but also “indirect” analyte determination, in which a sensing reagent is employed. Upon interaction with the analyte species, such a reagent undergoes a change in its optical property, e.g. elastic or inelastic scattering, absorption, luminescence intensity, luminescence lifetime or polarization state. Significantly, this sort of indirect detection combines chemical selectivity with that offered by the spectroscopic measurement and can often overcome otherwise troublesome interference effects.

Because spectrophotometric indicators were originally developed for aqueous applications, their immobilization into a solid support is a key issue for their application in optical sensing. Polymeric materials for reagent-based optical sensors are often complex multicomponent formulations. The key formulation ingredients include a chemically sensitive reagent (indicator), a polymer matrix, auxiliary minor additives, and a common solvent or solvent mixture. In the past, it has been difficult to predict the best formulation of the sensor material to yield a certain desired functionality.

It is known that a variety of chemical substances absorb light in proportion to the concentration of the substance present in the sample. Furthermore, the light transmitted through such a substance has an absorption spectrum characterized by the light absorbing properties of the substance and the properties of any other medium through which the light travels. Such absorption spectrum can be prismatically revealed for analysis. By discounting the portion of the absorption spectrum attributable to intensity losses and other absorbers, the spectrum of the chemical substance can be isolated and its identity and concentration determined. The discounting, or “referencing,” is done by determining the absorption spectrum of the light source and any spectrophotometric components in the absence of the chemical substance. Referencing is usually done close in time and space to the measurement of the absorbance of the chemical substance to minimize error.

It is well known that portable, battery-powered devices for determining the concentrations of chemical substances are commercially available. Examples include portable photometers provided by Hach Company (Loveland, Colo., USA) and portable reflectometers by Merck (Whitehouse Station, N.J., USA). A detailed review of photometric and reflectometric systems is given in Comprehensive Analytical Chemistry, Chemical Test Methods of Analysis, (Y. A. Zolotov et al., Elsevier, N.Y. (2002)), and in a review paper given in Review of Scientific Instruments, (Kostov, Y. and Rao, G., Vol. 71, 4361, (2000)). The adoption of these systems makes chemical analysis outside of a laboratory possible.

Other methods utilizing test strips have been widely attempted for semi-quantitative analysis for a large number of analytes. Here, quantitative results can be obtained with disposable optical sensor elements, read by a photometer. In most instances, only a single analyte is determined by an optical sensor element. Since transmission absorbance is measured, it is difficult to produce disposable optical sensor elements for calibration free tests.

Disposable chemical sensors are well known in the art. For example, U.S. Pat. No. 5,830,134 describes a sensor system for detecting physico-chemical parameters designed to compensate for numerous perturbing factors, such as those resulting from the use of partially disposable monitoring units, thus eliminating the need for calibration steps.

Another U.S. Pat. No. 5,156,972 discloses a chemical sensor based on light absorption, light emission, light scattering, light polarization, and electrochemically and piezoelectrically measured parameters. Scatter controlled emission for optical taggants and chemical sensors have been disclosed in U.S. Pat. No. 6,528,318. Sensor arrays that use reference and indicator sensors are known and described in U.S. Pat. No. 4,225,410. Here, a sensor can be individually calibrated, such that each analysis can be read directly.

U.S. Pat. No. 5,738,992 discloses a method that utilizes a reference material to correct fluorescence waveguide sensor measurements. U.S. Pat. No. 5,631,170 teaches a referencing method for fluorescence waveguide sensors by labeling the waveguide with a reference reagent.

Two-wavelength, or dual-beam, methods are known in spectrophotmetric analysis. In “Referencing Systems for Evanescent Wave Sensors,” (Stewart, G. et al., Proc. Of SPIE, 1314, 262 (1990)), a two-wavelength method is proposed to compensate for the effect of contamination on the sensor surface. U.S. Pat. No. 4,760,250 describes an optoelectronics system for measuring environmental properties in which feedback-controlled light sources are used to minimize problems associated with the light source stability and component aging. A similar feedback-controlled two-wavelength method is described in U.S. Pat. No. 3,799,672. A dual-beam reflectance spectrophotometer is described in “Optical Fiber Sensor for Detection of Hydrogen Cyanide in Air,” (Jawad, S. M. and Alder, J. F., Anal. Chim. Acta 259, 246 (1991)). In Jawad and Alder's method, two LED's are alternately energized. The ratio of outputs at the two wavelengths is used to reduce errors caused by the background absorption of the sensor element for hydrogen cyanide detection. These two-wavelength methods are effective to minimize errors caused by optical and mechanical component aging and long-term stability problems of light sources. However, errors associated with variations in the effective optical path length of disposable test elements have not been solved.

A disposable sensor system comprising a discardable or disposable measuring device and further comprising one or more sensors is disclosed in U.S. Pat. No. 5,114,859. Furthermore, analysis of multiple analytes is done with microfabricated sensors as described in U.S. Pat. No. 6,007,775.

Many standard methods for determining the concentration of a chemical and biological substance in a liquid sample involve multiple steps. A sample usually requires a pretreatment such as filtering and dilution. The treated sample needs to be transferred to a measurement chamber such as a cuvette. An analytical reagent is added to the sample in the cuvette by a single or multiple aliquots. Mixing the reagent with the sample thoroughly is essential for many applications. Finally, optical properties of the sample-reagent mixture are measured by bench-top apparatus and converted to a concentration unit by an embedded microprocessor.

A multi-step analytical procedure is time consuming. In addition, more steps usually lead to more operational errors, such as sample contamination. Thus, any simplification of conventional analytical procedures is desirable.

By analyzing relationships among the sample, operator, and sensor apparatus, one may recognize that an ideal sensor device may be like a temperature probe. To determinate the concentration of chemical and biological substances, a combined-electrode approach is probably the only approach that closely resembles a sensor for the measurement of physical properties. Unfortunately, reliable electrodes for analyzing a majority of chemical and biological species are not available. On the other hand, many reliable methods based on absorbance and fluorescence measurements have been developed. In addition, inexpensive optical and electronic component are widely available.

U.S. Pat. No. 5,844,686 discloses a hand apparatus comprising a pipetting means, an integrated photometer, and disposable pipette tip. The hand apparatus requires seals at both the distal and proximal openings of the tip. For carrying multiple reagents, a partition wall inside the tip is required. Presumably, the reagent or reagents are in liquid or solid powder format since seals at the openings are required. To bring the reagent to mix with the sample, one has to break at least one seal. For multiple reagent situations, one has to break a seal and a partition wall. In addition, U.S. Pat. No. 5,844,686 requires an optical path for absorbance measurements, such that the optical path of the photometer is directly across the wall of the pipette tip. The hand apparatus allows a sample to be withdrawn into the pipette tip and evaluated photometrically by the photometers integrated into the pipetting electronic means. The apparatus disclosed in U.S. Pat. No. 5,844,686 provides an optical reference path by means of attenuated total reflection element that is permanently connected to the pipette part of the apparatus. The function of the optical reference path is not defined in U.S. Pat. No. 5,844,686.

A need exists for a cost-effective and time-saving handheld sensor system that provides a platform for development of easy-to-use, portable, and inexpensive sensors for a variety of applications. In addition, a need exists for a system that simplifies conventional spectrophotometric methods for chemical or biological analysis.

### SUMMARY OF THE INVENTION

The present invention relates to a method that allows integration of sample handling, reagent addition, and optical measurement into an integrated handheld sensor system. With this system, analytical procedures based on wet chemistry absorbance, fluorescence, and other spectrophotometric measurements are simplified. A disposable reagent-carrying pipette tip provides means for sample pipetting and reagent addition, and defines an optical space for the optical measurement. Signal normalization based on an internal reference reagent or indicator and/or a second wavelength measurement can effectively reduce sensor errors caused by variations in the disposable pipette tip and its optical alignment with respect to the optical components of the handheld sensor system disclosed. The handheld sensor system disclosed in this invention provides a platform for development of an easy-to-use, portable, and inexpensive sensors for a variety of applications ranging from laboratory and field analysis to medical diagnosis and household testing.

A sensor system for determining the concentration of chemical and biological analytes is disclosed that is comprised of a disposable reagent-carrying pipette tip, a liquid handling unit to which the pipette tip can be detachably mounted, the liquid handling unit capable of withdrawing liquid into the pipette tip, at least one light source that is capable of emitting at least two colors of light, at least one photodetector, the detector capable of generating an electronic signal response indicative of light passed through or generated from the interior space of the pipette tip, and an electronic circuit means for processing, storing and transmitting the electronic signal response and controlling the light source.

The various features of novelty which characterize the invention are pointed out with particularity in the claims annexed to and forming a part of this disclosure. For a better understanding of the invention, its operating advantages and benefits obtained by its uses, reference is made to the accompanying drawings and descriptive matter. The accompanying drawings are intended to show examples of the many forms of the invention. The drawings are not intended as showing the limits of all of the ways the invention can be made and used. Changes to and substitutions of the various components of the invention can of course be made. The invention resides as well in sub-combinations and sub-systems of the elements described, and in methods of using them.

### BRIEF DESCRIPTION OF THE DRAWINGS

FIG. 1a is a disposable reagent-carrying pipette tip in which the reagent is dispersed in a porous plug which is located at the lower part of the pipette tip in accordance with one embodiment of the present invention;

FIG. 1b is a disposable reagent-carrying pipette tip in which a solid reagent is placed in a gap created by two porous plugs in accordance with an embodiment of the present invention;

FIG. 1c is a disposable reagent-carrying pipette tip in which a polymer film containing a reagent is coated on the interior surface of the pipette tip in accordance with an embodiment of the present invention;

FIG. 2a is a pipette tip with a light pipe molded onto the inside wall of the pipette tip in accordance with an embodiment of the present invention;

FIG. 2b is a pipette tip with a light pipe molded onto the outside wall of the pipette tip in accordance with an embodiment of the present invention;

FIG. 2c is a pipette tip that has a metallized exterior surface in accordance with an embodiment of the present invention;

FIG. 3 is a light source and detection arrangement where both the light source and detector are installed inside the liquid handling unit in accordance with an embodiment of the present invention;

FIG. 4 is a light source and detection arrangement where both the light source and detector are installed in a device detachable from the pipette body in accordance with an embodiment of the present invention;

FIG. 5a is a light source and detection arrangement where the light source is installed inside the liquid handling unit in accordance with an embodiment of the present invention;

FIG. 5b is a light source and detection arrangement where the light source is installed outside the liquid handling unit in accordance with an embodiment of the present invention;

FIG. 6 is a light-source assembly in accordance with an embodiment of the present invention;

FIG. 7 is an example of a calibration curve for log(R0/R)−log(G0/G) as a function of chlorine concentration;

FIG. 8 is an example of a calibration curve for log(R/G) as a function of chlorine concentration;

FIG. 9 is an example of intensity signals R and G as a function of chlorine concentration;

FIG. 10 is a light source and light detector configuration in accordance with an embodiment of the present invention; and

FIG. 11 is an example of a calibration curve for a correlation of log(R0/R) to the absorbance value measured at 650 nm by a bench-top spectrophotometer.

### DETAILED DESCRIPTION OF THE INVENTION

While the present invention has been described with references to preferred embodiments, various changes or substitutions may be made on these embodiments by those ordinarily skilled in the art pertinent to the present invention with out departing from the technical scope of the present invention. Therefore, the technical scope of the present invention encompasses not only those embodiments described above, but also all that fall within the scope of the appended claims.

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

The present invention relates to a method that allows integration of sample handling, reagent addition, and optical measurement into an integrated handheld sensor system. This invention discloses a method of integrating the four most important components found in conventional analytical system—fluidic device, reagent, optical and electronic components—into a compact, handheld sensor apparatus. With this system, analytical procedures based on wet chemistry absorbance, fluorescence, and other spectrophotometric measurements are simplified. A disposable reagent-carrying pipette tip provides a means for sample pipetting and reagent addition, and defines a body of a material for the optical measurement. Signal normalization based on an internal reference reagent and/or a second wavelength measurement can effectively reduce sensor errors caused by variations in the disposable pipette tip and its optical alignment with respect to the optical components of the handheld sensor system disclosed. The handheld sensor system disclosed in this invention provides a platform for development of an easy-to-use, portable, and inexpensive sensors for a variety of applications ranging from laboratory and field analysis to medical diagnosis and household testing.

The present invention pertains to a method and apparatus for determining the concentrations of chemical substances (analytes) by utilizing their reactive properties with certain chemical reagents; for example, the analyte-reagent reaction producing a product that has a visible absorption spectrum different from the reagent and analyte themselves. In operation, the present invention measures the reagent-containing test element response to specific analytes through a change in light absorbance, luminescence, light scattering, or other light-based response. The analytes described in this invention are chemical species, but this invention can also be envisioned to include biological systems where bioanalyte interactions stimulate similar test element response. As an example, such biological systems could be immobilized enzymes that stimulate light response proportional to an analytes concentration, for example, luciferase response to adenosine triphosphatase (ATP).

Materials utilized as analyte-specific reagents incorporate dyes and reagents known in the art as indicators. As used herein, analyte-specific reagents are indicators that exhibit calorimetric, photochromic, thermochromic, fluorescent, elastic scattering, inelastic scattering, polarization, or any other optical property useful for detecting physical properties and chemical species. Analyte-specific reagents include organic and inorganic dyes and pigments, nanocrystals, nanoparticles, quantum dots, organic fluorophores, inorganic fluorophores and similar materials.

A sensor system for determining a concentration of chemical and biological analytes is disclosed, which is comprised of a disposable reagent-carrying pipette tip; a liquid handling unit to which the pipette tip can be detachably mounted, the liquid handling unit capable of withdrawing liquid into the pipette tip; at least one light source that is capable of emitting two colors of light; at least one photodetector, the detector capable of generating an electronic signal response indicative of light passed through or generated from the interior space of the pipette tip; and an electronic circuit means for processing, storing, and transmitting the electronic signal response and controlling the light source. In one embodiment, the reagent contains a reference indicator and responsive indicator that reacts with the analyte to produce a spectrophotometric change. In an alternate embodiment, the reference indicator is negligibly responsive to the analyte and its spectrophotmetric characteristics is substantially different from that of the responsive indicator.

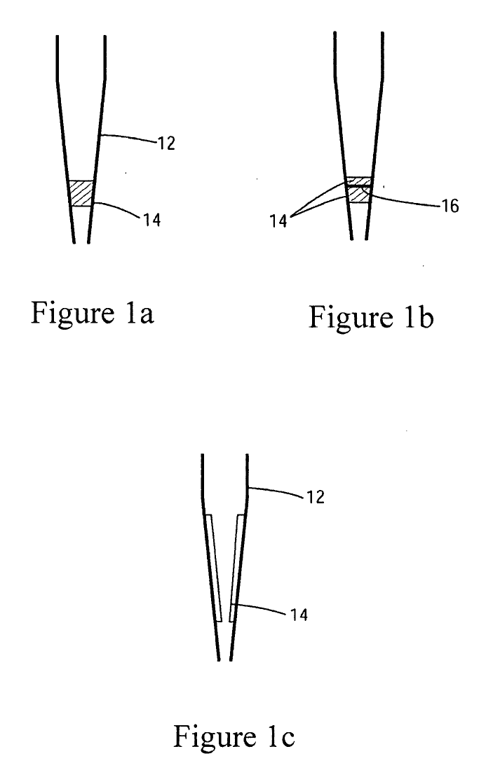

FIGS. 1a, 1b, and 1c demonstrate a disposable reagent-carrying pipette tip 12 in accordance with embodiments of the present invention. The system disclosed in the present invention introduces a reagent into the pipette tip 12 by means of polymer coating and/or dissolution through a porous plug 14. The reagent 16 is needed to react with analytes in order to produce a color product. This system is simpler than prior art systems in which in order to bring the reagent to mix with the sample, one has to break at least one seal or a seal and a partition wall.

A reagent or reagents 16 may be immobilized in the pipette tip 12 in several ways, as shown in FIG. 1a and FIG. 1b. The porous plugs 14 provide a means for reagent immobilization. In addition, the porous plugs 14 provide a means for inline filtration and mixing. Filtration is an essential sample pretreatment step in many wet analytical methods. As a sample is passed through a porous media, dissolution of the immobilized reagent takes place, resulting in well-mixed solution.

In one embodiment the disposable reagent-carrying pipette tip 12 demonstrated in FIG. 1a can be prepared by first inserting a porous plug 14 into the lower part of the pipette tip 12 and the tip-plug assembly is immersed into the reagent 16, which allows the reagent to disperse and enter pores in the plug 14. The plug 14 and pipette tip 12 is then removed from the reagent solution and dried under conditions that are compatible with the reagent. In an alternate embodiment, the porous plug 14 is treated with the reagent solution before being inserted into the pipette tip 12. FIG. 1b demonstrates a disposable reagent-carrying pipette tip 12 in which a solid reagent is placed in a gap created by two porous plugs located in the lower part of the pipette tip 12. FIG. 1c demonstrates a disposable reagent-carrying pipette tip 12 in which a polymer film containing a reagent is coated on the interior surface of the pipette tip 12, in accordance with an additional embodiment of the invention.

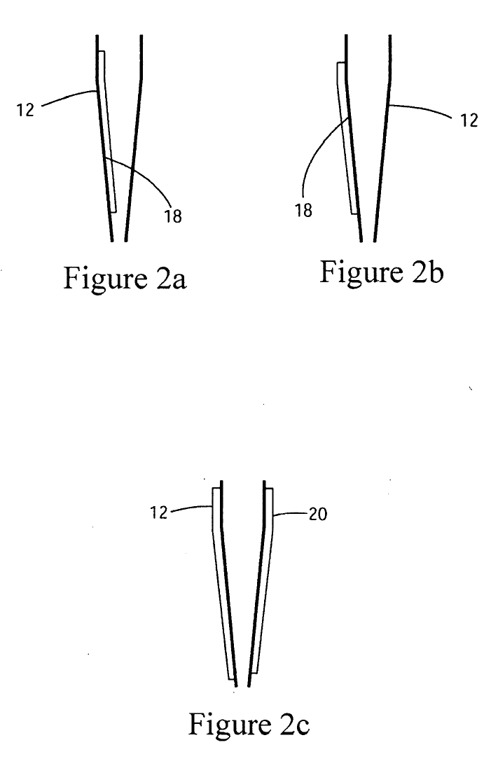

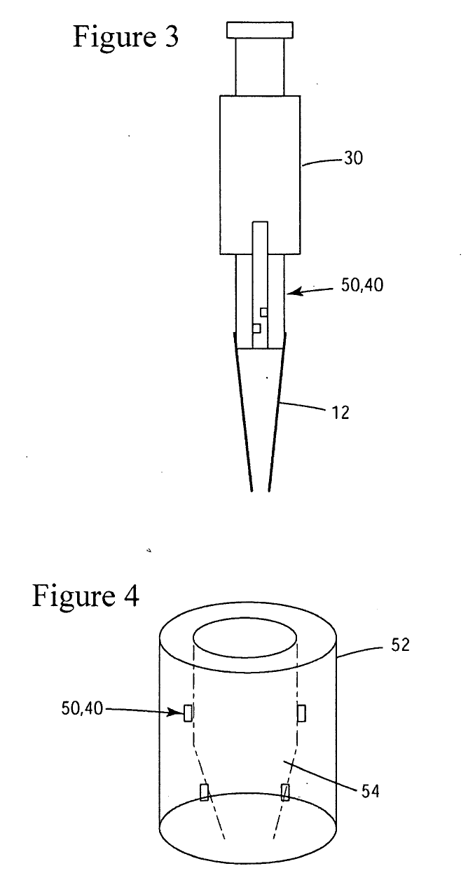

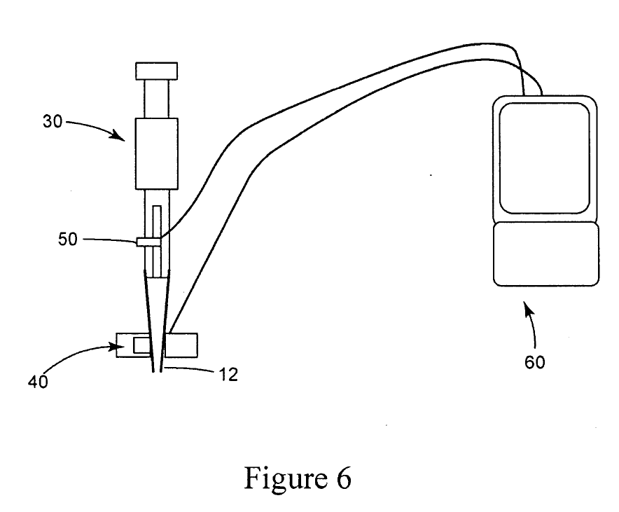

When the pipette tip 12 is manufactured by an injection molding process, other features may be incorporated into the sensor system in order to improve system performance, as shown in FIGS. 2a, 2b, and 2c. In one embodiment, a light pipe 18 is molded onto the inside wall of the pipette tip 12, as shown in FIG. 2a. In an alternate embodiment, a light pipe 18 is molded onto the outside wall of the pipette tip 12, as shown in FIG. 2b. In order to transmit light generated by the light source installed in the liquid handling unit 30 to the pipe via the light pipe 18, the liquid handling unit 30 needs to provide a light coupling means. The liquid handling unit 30, as shown in FIGS. 3 and 6, may also referred to as the pipette body or body of the pipette.

In one embodiment, the pipette tip 12 has a metallized exterior surface 20. As shown in FIG. 2c, this metallized reflective coating can reduce the effect of ambient light on the optical measurements. In addition, it provides multiple internal reflections inside the pipette tip 12 and results in an increase in effective optical path length. The metallized exterior surface 20 may be any known reflective coatings known in the art, such as but not limited to, aluminum and gold.

The sensor system is comprised of a liquid handling unit 30 to which the pipette tip 12 may be detachably mounted, the liquid handling unit 30 capable of withdrawing liquid into the pipette tip 12. In one embodiment of the present invention, the liquid handling unit 30 may be a motorized pipette controlled with a microprocessor. The microprocessor and its auxiliary circuit may be used to control the light and read the output of the photodiode. In an alternate embodiment, the liquid handling unit 30 may be a manually operated pipette, in which necessary electronics may be built into the pipette for spectrophotometic measurements. In both embodiments, synchronization between liquid sample withdrawal, spectrophotometric measurement, and discharging the liquid from the pipette tip 12 when the measurement is completed is necessary.

The sensor system is also comprised of at least one light source 40, which can be any means that is capable of emitting light energy. Many light sources 40 may be selected for this application, such as multi-color LEDs, diode lasers, or miniature light bulbs. For the purpose of signal normalization, the light source 40 should be capable of emitting two colors of light. This can be achieved by using a multi-color LED or multiple LEDs and other light sources.

The sensor system further comprises at least one photodetector 50 or light detector, which can be any means that is capable of detecting light energy and converting the energy to electrical output signals that are indicative of the test elements response to the target analyte or analytes. It is understood that many commercially available photodetectors 50 or light detectors could be used to achieve the desired performance, such as photodiode, micromachined photo multiplier tube, or photocell, and are well known in the art. For absorbance measurement, miniature photodiodes and phototransistors may be used. For chemiluminescence and fluorescence measurements, photomultiplier tube (PMT) may be used. If a white light is used as the light source, a color sensor may be selected. Similarly, if a single wavelength light source is used, a detector that covers a wide range of spectrum is suitable. In one embodiment, the detector 50 is comprised of photodiodes, phototransistors, photomultiplier tubes (PMT), color sensors, and detectors that cover a wide range of the spectrum. Other light sources 50 known in the art may be used.

The light source 40 and detector 50 can be arranged in several ways, as shown in the figures. In one embodiment, both the light source 40 and detector 50 are installed inside the liquid handling unit 30, and there is no clearly defined optical path length, as shown in FIG. 3. In a defined light path, the light from the light source 40 has a single path to reach the light detector 50. When there is no well-defined optical path, then the light from the light source 40 has a multitude of paths that can be taken to reach the light detector 50. In the present invention, because there is no well-defined optical path, a normalization method is needed to eliminate errors in absorbance measurement. The light path in the present invention includes the whole body of pipette tip 12, as the light from the light source 40 on the bottom of the system can travel up to the photodiode, without a limitation on the path that the light can travel. This embodiment differentiates the present invention from prior art because in methods disclosed in the prior art, optical and fluidic components are arranged in such a way that provides a well-defined optical path length, using lens, mirrors, and optical windows. In the present invention, a well-behaved calibration curve, linear or nonlinear, may be obtained without providing a defined optical path. In addition, measurement errors caused by tip-to-tip variations may be effectively reduced by the disclosed signal normalization method.

In another embodiment, both the light source 40 and detector 50 are installed in a device 52 detachable from the liquid handling unit 30. This configuration is demonstrated in FIG. 4. In an alternate embodiment, the device 52 detachable from the liquid handling unit 30 has a chamber 54 that holds the pipette tip 12. The device detachable from the liquid handling unit 30 may have an independent circuit for data processing. Alternatively, the device detachable from the liquid handling unit may connect to the electronic circuit of the sensor system. To use the embodiment shown in FIG. 4, an operator first loads the disposable tip to the liquid handling unit 30, draws the sample solution into the pipette tip 12, then places the pipette tip 12 into the chamber 54. Changes in optical properties caused by the reagent-analyte reaction are measured while the pipette tip 12 is held by the chamber 54.

In the arrangement in which the light source 40 and detector 50 are installed in a device detachable from the liquid handling unit 30, an ultrasonic wave generator may be embedded in the sensor system. The ultrasonic wave can help sample-reagent mixing. Because of the intimate contact of the pipette tip 12 with the wall of the chamber, a thin-film heating/cooling element and temperature sensor can be fixed on the interior wall of the chamber for temperature measurement and control. The ability to control sample temperature allows the system to measure samples with different initial temperatures and allows for either a standardization of measurement temperature to possibly an elevated temperature from the ambient and/or an increased tip temperature to accelerate the reagent-sample reaction.

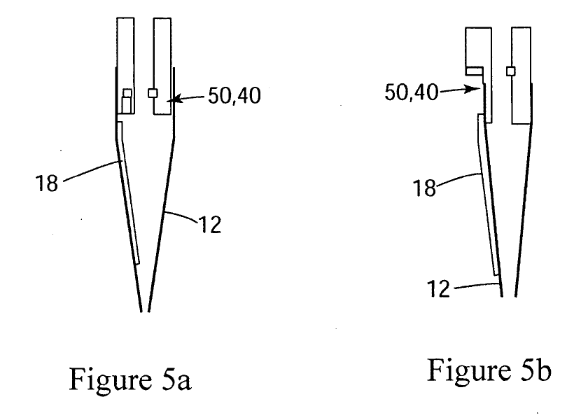

The light source 40 may be installed inside the liquid handling unit 30 in such a way that provides illumination to the light pipe 18 described in FIGS. 2a and 2b. In one embodiment, the light source 40 is installed inside the liquid handling unit 30, providing illumination to the light pipe 18 molded onto the inside wall of the pipette tip 12, as shown in FIG. 5a. In an alternate embodiment, the light source 40 is installed outside the liquid handling unit 30, providing illumination to the light pipe 18 molded onto the outside wall of the pipette tip 12, as shown in FIG. 5b. In another embodiment of the present invention, the light detector 50 is fixed inside the liquid handling unit 30 and the light source 40 is installed in a device detachable from the liquid handling unit 52. This configuration is demonstrated in FIG. 6. In this configuration, the light detector 50 is fixed inside the airway of the liquid handling unit 30.

The sensor system is also comprised of an electronic circuit means 60, as shown in FIG. 6, for processing, storing and transmitting the electronic signal response and controlling the light source. Suitable electronic circuit means 60 are provided which allow a signal converter to communicate with a signal processing unit so that electrical output signals generated by the photodetector 50 can be processed and stored electronically. It is understood that many well-known configurations can be utilized in a manner known in the art to achieve the same performance as the above embodiment, including an embodiment capable of communicating via interface with an external processing unit, for example a handheld computer, PDA, or other wireless transmission device. Moreover, it is understood that an embodiment comprising a built-in processing unit could be used as well.

The invention also provides methods for quantitating the concentration of an analyte by measuring an optical property of a sample or a change resulted in by the sample-reagent reaction. A method for determining analyte concentration of a chemical and biological substance is disclosed, which is comprised of providing a reagent-carrying disposable pipette tip; mounting the pipette tip to a liquid handling unit measuring at least two initial spectrophotometric parameters before a liquid sample is drawn into the liquid handling unit; drawing the liquid sample into the pipette tip; measuring two response spectrophotometric parameters at a give time or multiple times; calculating a normalized parameter using initial parameters and response parameters; and converting the normalized parameter to a concentration of analyte. The spectrophotometric parameters are absorbance, fluorescence, and other spectrophotometric measurements.

A significant source of error in a system using a disposable element is caused by variations from one disposable element to another, such as variations in geometric parameters of the disposable elements or variations in alignment of the disposable element with respect to the pipette. The error caused by these variations can be eliminated by signal normalization. Several signal normalization methods may be used. For example, as shown in the Examples below, absorbance values at one wavelength may be used as the main signal and absorbance at another wavelength may be used as a reference signal. The main absorbance value may be normalized by calculating the difference in the signals or the ratio or the combination of both.

There are many ways to select the reference wavelength at which the reference signal is measured. The reference wavelength could be substantially different from the main wavelength at which the main signal is measured. The reference wavelength could be any wavelength at which the reagent by itself exhibits some spectral features. For instance, if the reagent is a dye, then the reference wavelength could be the main absorption peak while the main wavelength could be the main absorption peak of the reagent-analyte reaction product. If the reagent has no spectral features that can be measured, a reference reagent can be added into the reagent composition. For example in a calorimetric measurement, if the reagent is colorless, a dye can be added to the reagent composition as the reference reagent. In this case, the main absorption peak of the reference dye could be chosen as the reference wavelength.

In one embodiment, the reagent contains a reference indicator. One of the spectrophotometric parameters is measured from a reference indicator and the other spectrophotometric parameter is measured from a response indicator. The indicators reacts with the analyte to produce a spectrophotometric change. The second parameter is a measure of analytical information. In another embodiment, the reagent does not contain a reference indicator and the first parameter is measured from the reference wavelength. The reference indicator is negligibly responsive to the analyte and its spectrophotmetric characteristics is substantially different from that of the responsive indicator. A normalized parameter or signal is calculated from the main signal and the reference signal, as further described in the Examples below. In one embodiment, the normalized parameter is calculated according to the difference between the first and second parameters, the ratio of the first and second parameters, or a combination of the difference and the ratio.

The invention is illustrated in the following non-limiting examples, which are provided for the purpose of representation, and are not to be construed as limiting the scope of the invention. All parts and percentages in the examples are by weight unless indicated otherwise.

### EXAMPLES

### Example 1

As shown in FIG. 6, a rectangle opening was made on the wall of a 1 ml pipette 10. A light-to-voltage sensor (TSL 257 from Taos Inc. (Plano, Tex., USA)) was inserted into the rectangle opening. The airway of the pipette 10, partly blocked by the photodiode 50, provides an optical path to the pipette tip 12 when it is loaded onto the pipette 10. The interior surface of a 1 ml polyethylene pipette tip 12 was coated with a polymer film containing chlorine sensitive reagent tetramethylbenzidine (TMB). FIG. 6 demonstrates the light-source 40 assembly. According to FIG. 6, two holes were drilled on a ¾×¾×⅜ inch plastic slab. A bicolor 5 mm LED (630 nm and 535 nm) was fixed into the horizontal hole. The light source 40 assembly was attached to the lower part of the pipette tip 12 through the vertical hole. A data acquisition CF card installed in a pocket computer 60 provided control and data reading for the photodiode 50 and the LED 40.

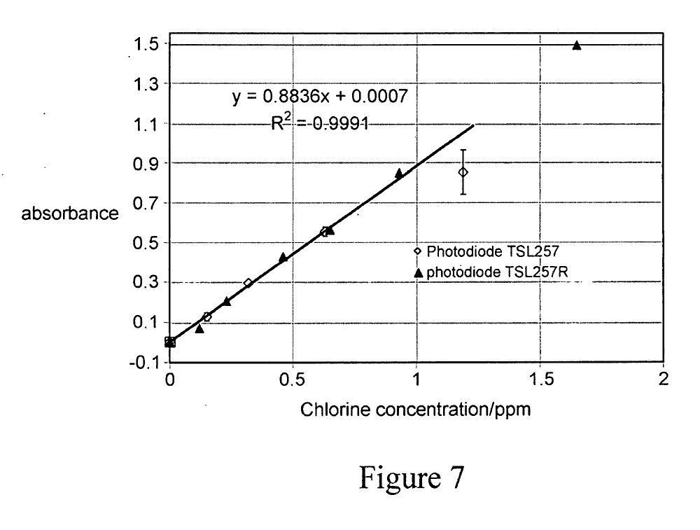

The pipette tip 12 containing chlorine sensitive reagent film was first loaded onto the pipette 10. The computer turns the green (525 nm) and red lights (630 nm) sequentially, and takes respective readings (Gₒ and Rₒ) from the photodiode while the green and red lights are turned on. Then, chlorine standard solutions were drawn into the pipette tip. The solution in the pipette tip 12 was flushed out and back into the tip by injecting to a 5 ml disposable polyethylene beaker and aspirating back to the pipette tip. This process was repeated three times to accelerate mixing and release of the reagent immobilized from within the polymer film and mix well with the sample. Finally, The DC voltage output from the photodiode (G and R) was recorded while the green and red lights were turned on. Absorbance, calculated as log(R0/R) or log(G0/G), is shown as a function of chlorine concentration in FIG. 7. Since TMB reacts with chlorine to produce a blue substance that has its maximum absorbance around 660 nm, it is desirable to use log(G0/G) as a baseline signal for absorbance normalization and log(R0/R)−log(G0/G) to quantify chlorine concentration. FIG. 7 demonstrates log(R0/R) minus log(G0/G) as a function of chlorine concentration.

The results obtained using a second pipette that has a light-to-voltage sensor (TSL 257R from Taos Inc. (Plano, Tex., USA)) are also shown in FIG. 7. The agreement between two sets of data is excellent. This indicates that the absorbance normalization from calculating the difference of log(R0/R)−log(G0/G) can effectively eliminate variations caused by variations in the preparation of disposable pipette tips. In this example, no reference indicator was used. The reference absorbance log(G0/G) was measured at the reference wavelength provided by the green LED where TMB and TMB-chlorine reaction product exhibit little absorption characteristics. Signal normalization is used to calculate the difference of log(R0/R)−log(G0/G).

### Example 2

A method to immobilize a chlorine sensitive reagent N,N-diethylphenylenediamine (DPD) in a porous polymeric plug 14 inserted inside the pipette tip 12 was demonstrated, using the configuration as shown in FIG. 1a. The light source and photodiode arrangements were the same as described in Example 1. As depicted in FIG. 1a, plugs 14, cut from porous sheet from Porex Inc. (Fairburn, Ga., USA), were inserted into the pipette tips 12. The pipette tips 12 were soaked in a solution containing DPD and buffer reagents for 1 minute. The pipette tips 12 were then put in a vacuum oven and dried for 18 hours.

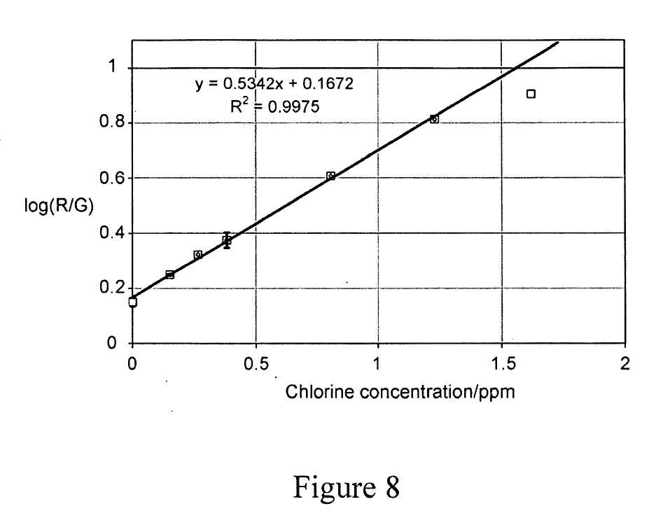

The pipette tip containing the chlorine sensitive reagent was first loaded onto the pipette. The computer turns the green (525 nm) and red lights (630 nm) sequentially, and took respective readings (Gₒ and Rₒ) from the photodiode while the green and red lights were turned on. Then, chlorine standard solutions were aspirated into the pipette tip. While the sample flowed through the porous plug, reagent dissolution took place. No other forced mixing was required. Finally, the DC voltage output from the photodiodes (G and R) were recorded while the green and red lights were turned on. FIG. 8 demonstrates log(R/G) as a function of chlorine concentration. Since DPD reacts with chlorine to produce a red color reaction product, the response wavelength was provided by the green LED while the reference wavelength was provided by the red LED. Absorbance normalization was achieved by calculating the logarithm of the ratio of green intensity (G) to red intensity (R).

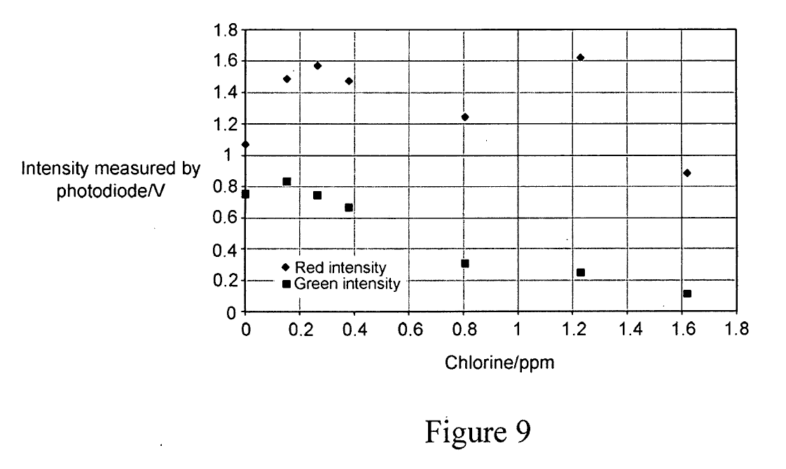

Photodiode output G and R are shown as a function of chlorine concentration in FIG. 9. As can be seen, neither G nor R individually represents chlorine concentration well. This example demonstrates that absorbance normalization is essential in a handheld sensor system using a disposable element.

### Example 3

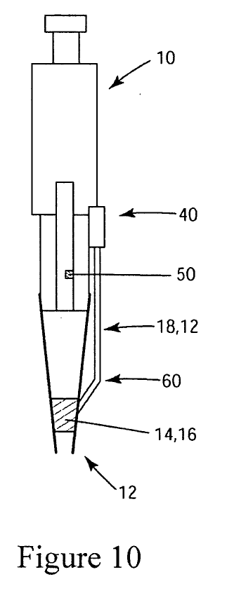

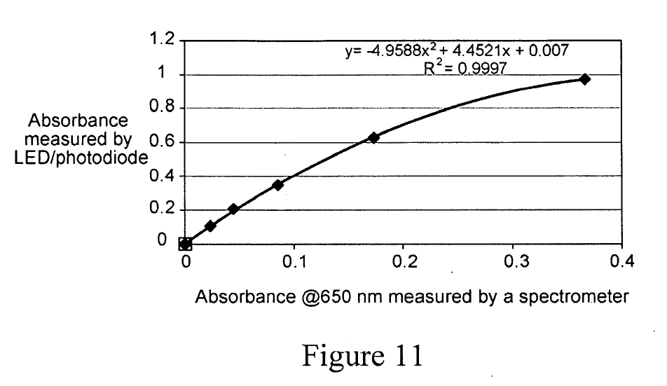

A light source and light detector configuration was used, as shown in FIG. 5b. In this configuration, a bicolor LED 40 (green and red) was installed on the outside wall of the pipette tip 12, while a light-to-voltage sensor (TSL 257 from Taos Inc. (Plano, Tex., USA)) was fixed inside the airway of the pipette. A 3 mm diameter acrylic rod was fixed to a 1 ml pipette tip 12 using epoxy glue. One end of the acrylic rod 60 was slightly bent toward the pipette tip 12 to direct the light to illuminate on the tip wall, as shown in FIG. 10. No well-defined optical path length was provided in this configuration. In order to examine whether this setup would provide quantitative measurement of absorbance, the light-to-voltage sensor outputs for both green and red LED were measured while a blue dye solution was drawn to the pipette tip. FIG. 11 demonstrates the correlation of log(R0/R) versus the absorbance value measured at 650 nm in a 1 cm cuvette by a bench-top spectrophotometer. Although the correlation is nonlinear, it is monotonic. Therefore the quantitative relationship between log(R0/R) and the absorbance from standard equipment is established.

While the present invention has been described with references to preferred embodiments, various changes or substitutions may be made on these embodiments by those ordinarily skilled in the art pertinent to the present invention without departing from the technical scope of the present invention. Therefore, the technical scope of the present invention encompasses not only those embodiments described above, but all that fall within the scope of the appended claims.

This written description uses examples to disclose the invention, including the best mode, and also to enable any person skilled in the art to practice the invention, including making and using any devices or systems and performing any incorporated processes. The patentable scope of the invention is defined by the claims, and may include other examples that occur to those skilled in the art. These other examples are intended to be within the scope of the claims if they have structural elements that do not differ from the literal language of the claims, or if they include equivalent structural elements with insubstantial differences from the literal languages of the claims.

What is claimed is:

1. A sensor system for determining concentration of chemical and biological analytes, comprising:
a. a disposable reagent-carrying pipette tip;
b. a liquid handling unit to which the pipette tip can be detachably mounted, the liquid handling unit capable of withdrawing liquid into the pipette tip;
c. at least one light source that is capable of emitting at least two colors of light;
d. at least one photodetector, the detector capable of generating an electronic signal response indicative of light passed through or generated from the interior space of the pipette tip; and
e. an electronic circuit means for processing, storing and transmitting the electronic signal response and controlling the light source.

2. The sensor system of claim 1 wherein a reagent is immobilized in the pipette tip.

3. The sensor system of claim 2 wherein the reagent is dispersed in a porous plug, located in a lower part of the pipette tip.

4. The sensor system of claim 2 wherein a solid reagent is placed in a gap created by two porous plugs located in a lower part of the pipette tip.

5. The sensor system of claim 2 wherein a polymer film containing a reagent coats an interior surface of the pipette tip.

6. The sensor system of claim 1 wherein the pipette tip is produced by injection molding.

7. The sensor system of claim 6 wherein the pipette tip incorporates a light pipe molded onto the inside wall of the pipette tip.

8. The sensor system of claim 6 wherein the pipette tip incorporates a light pipe molded onto the outside wall of the pipette tip.

9. The sensor system of claim 6 wherein the liquid handling unit that the pipette tip is detachably mounted to provides a light coupling means to the light pipe.

10. The sensor system of claim 8 wherein the pipette tip has a metallized exterior surface.

11. The sensor system of claim 1 wherein the liquid handling unit is a motorized pipette controlled with a microprocessor.

12. The sensor system of claim 1 wherein the liquid handling unit is a manually operated pipette in which electronics are be built into the pipette for spectrophotometric measurements.

13. The sensor system of claim 1 wherein the light source is comprised of multi-color LEDs, diode lasers, and miniature light bulbs.

14. The sensor system of claim 1 wherein the photodetector is comprised of photodiodes, phototransistors, photomultiplier tubes (PMT), color sensors, and detectors that cover a wide range of spectrum.

15. The sensor system of claim 1 wherein both the light source and detector are installed inside the liquid handling unit and there is no clearly defined optical path length.

16. The sensor system of claim 1 wherein both the light source and detector are installed in a separate device detachable from the liquid handling unit.

17. The sensor system of claim 16 wherein the device detachable from the liquid handling unit has a chamber to receive the pipette tip.

18. The sensor system of claim 16 wherein the device detachable from the liquid handling unit has an independent circuit for data processing.

19. The sensor system of claim 16 wherein the device detachable from the liquid handling unit connects to the electronic circuit of the sensor system.

20. The sensor system of claim 16 wherein change in spectrophotometric properties caused by the reagent-analyte reaction is measured while the pipette tip is held by the chamber.

21. The sensor system of claim 16 wherein an ultrasonic wave generator is embedded in the sensor system.

22. The sensor system of claim 16 wherein a thin-film heating or cooling element and temperature sensor is fixed on the interior wall of the chamber for temperature measurement and control.

23. The sensor system of claim 1 wherein the detector is fixed inside the liquid handling unit and the light source is installed in a device detachable from the body of the liquid handling unit.

24. The sensor system of claim 23 wherein the light source is installed inside the liquid handling unit, providing illumination to the light pipe molded onto the inside wall of the pipette tip.

25. The sensor system of claim 23 wherein the light source is installed outside the liquid handling unit, providing illumination to the light pipe molded onto the outside wall of the pipette tip.

26. The sensor system of claim 1 wherein the reagent contains a reference indicator and responsive indicator that reacts with the analyte to produce a spectrophotometric change.

27. The sensor system of claim 26 wherein the reference indicator is negligibly responsive to the analyte and its spectrophotmetric characteristics is substantially different from that of the responsive indicator.

28. A method for determining analytes concentration of a chemical and biological substance, the method comprising:
a. providing a reagent-carrying disposable pipette tip;
b. mounting the pipette tip to a liquid handling unit;
c. measuring at least two initial spectrophotometric parameters before a liquid sample is drawn into the liquid handling unit;
d. drawing the liquid sample into the pipette tip;
e. measuring two response spectrophotometric parameters at a give time or multiple times;
f. calculating a normalized parameter using initial parameters and response parameters; and
g. converting the normalized parameter to a concentration of analyte.

29. The method of claim 28 wherein the spectrophotometric parameters are absorbance, fluorescence, or other spectrophotometric measurements.

30. The method of claim 28 wherein the reagent contains a reference indicator.

31. The method of claim 30 wherein one spectrophotometric parameter is measured from a reference indicator and the other spectrophotometric parameter is measured from a response indicator.

32. The method of claim 31 wherein the second parameter is a measure of analytical information.

33. The method of claim 28 wherein the reagent does not contain a reference indicator and the first parameter is measured from a reference wavelength.

34. The method of claim 31 wherein the reference indicator is negligibly responsive to the analyte and its spectrophotmetric characteristics is substantially different from that of the responsive indicator.

35. The method of claim 33 wherein a normalized parameter or a normalized signal is calculated using the main signal and the reference signal.

36. The method of claim 35 wherein the normalized parameter is calculated according to the difference between the first and second parameters, the ratio of the first and second parameters, or a combination of the difference and the ratio.
